(19) United States
(12) Patent Application Publication
(10) Pub. No.: US 2026/0110437 A1
(43) Pub. Date: Apr. 23, 2026

(54) MODULAR ASSEMBLY FOR REAR PROJECTION ELECTRIC FIREPLACE

(71) Applicant: Greentouch USA, Inc., Miami Beach, FL (US)

(72) Inventor: William Scott Bourne, Boynton Beach, FL (US)

(21) Appl. No.: 19/364,533

(22) Filed: Oct. 21, 2025

Related U.S. Application Data
(60) Provisional application No. 63/710,377, filed on Oct. 22, 2024.

(51) Int. Cl. F24C 7/00; F21S 10/04

(52) U.S. Cl. CPC F24C 7/004; F21S 10/046

(57) ABSTRACT

An electric fireplace (14) for installation into a cabinet (12) having a cabinet opening (12A) includes a heater assembly (16) and a fireplace insert (22). The heater assembly (16) is configured to generate heated air. The fireplace insert (22) is configured to be installed into the cabinet opening (12A) independently of the heater assembly (16). The fireplace insert (22) includes a simulated flame assembly (30) that projects a flame-like image onto a surface (750A) to create a simulated flame (630A) within the electric fireplace (14). The simulated flame assembly (30) can include a projection screen (550) and a flame illumination system (552) that projects the flame-like image onto a rear surface (750A) of the projection screen (550).

### RELATED APPLICATIONS

This application claims priority on U.S. Provisional Patent Application Ser. No. 63/710,377, filed on Oct. 22, 2024, and entitled “MODULAR ASSEMBLY FOR REAR PROJECTION ELECTRIC FIREPLACE”. As far as permitted, the contents of U.S. Provisional Patent Application Ser. No. 63/710,377 are incorporated in their entirety herein by reference.

### BACKGROUND

Electric fireplaces have become increasingly popular in recent years. An electric fireplace is typically designed to look like a traditional wood-burning fireplace, but does not actually burn wood. Typically, electric fireplaces are completely assembled and wired, and thus takes up a lot of space for packaging, shipping and storing. Additionally, since such inserts typically come already assembled, such currently available electric fireplaces also do not generally allow for substantial variability for the consumer in terms of the overall size, shape, design and aesthetic appearance of the electric fireplace.

Thus, there is a desire to allow greater variety in the size, shape, design and aesthetic appearance of the electric fireplace for the consumer, while still enabling various product development, packaging, shipping, storing and overall cost efficiencies.

### SUMMARY

The present invention is directed toward an electric fireplace for installation into a cabinet having a cabinet opening. In various embodiments, the electric fireplace includes a heater assembly and a fireplace insert. The heater assembly is configured to generate heated air. The fireplace insert is configured to be installed into the cabinet opening independently of the heater assembly. The fireplace insert includes a simulated flame assembly that projects a flame-like image onto a surface to create a simulated flame within the electric fireplace.

In several embodiments, the simulated flame assembly includes a projection screen and a flame illumination system that projects the flame-like image onto a rear surface of the projection screen.

In some embodiments, the flame illumination system includes a flame light source that generates light which can be used to project the flame-like image onto the rear surface of the projection screen.

In certain embodiments, the flame illumination system further includes a beam redirector assembly that redirects the light generated by the flame light source toward the rear surface of the projection screen.

In some embodiments, the beam redirector assembly includes an array of reflectors that are mounted on a beam redirector rod having a rod axis, the array of reflectors being rotatable about the rod axis.

In certain embodiments, rotation of the array of reflectors about the rod-like axis causes the flame-like image that is projected onto the rear surface of the projection screen appears to flicker.

In some embodiments, the flame illumination system further includes a light shaper that shapes the light generated by the flame light source prior to the light being used to project the flame-like image onto the rear surface of the projection screen.

In certain embodiments, the light shaper includes a shaper housing and a flame-like cutout that is formed into the shaper housing.

In many embodiments, the electric fireplace further includes an electrical connection assembly that selectively, electrically connects the fireplace insert to the heater assembly.

In some embodiments, the electrical connection assembly includes a low-voltage DC connector that selectively, electrically connects the fireplace insert to the heater assembly.

In certain embodiments, the electrical connection assembly further includes an AC power cord that selectively, electrically connects the heater assembly to an external power source.

In several embodiments, the electric fireplace further includes a controller including a processor that is coupled to the heater assembly, the controller being configured to control operation of the heater assembly and the fireplace insert.

In some embodiments, the fireplace insert includes at least one of an ember bed and a log assembly.

In other embodiments, the fireplace insert includes each of the ember bed and the log assembly.

In certain embodiments, the heater assembly is positioned above the fireplace insert when the heater assembly and the fireplace insert are installed within the cabinet opening.

The present invention is further directed toward an electric fireplace for installation into a cabinet having a cabinet opening, the electric fireplace including (a) a heater assembly that is configured to generate heated air; (b) a fireplace insert that is configured to be installed into the cabinet opening independently of the heater assembly, the fireplace insert including a simulated flame assembly including a projection screen and a flame illumination system that projects a flame-like image onto a rear surface of the projection screen, the flame illumination system including (i) a flame light source that generates light, (ii) a beam redirector assembly that redirects the light generated by the flame light source toward the rear surface of the projection screen, the beam redirector assembly including an array of reflectors that are mounted on a beam redirector rod having a rod axis, the array of reflectors being rotatable about the rod axis, and (iii) a light shaper that shapes the light generated by the flame light source and redirected by the beam redirector assembly prior to the light being used to project the flame-like image onto the rear surface of the projection screen; and (c) an electrical connection assembly that selectively, electrically connects the fireplace insert to the heater assembly.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified front view illustration of a cabinet assembly including a cabinet and an embodiment of an electric fireplace having features of the present invention that is positioned within and/or integrated into the cabinet;

FIG. 2 is a simplified rear view illustration of the cabinet assembly of FIG. 1, including the cabinet and the electric fireplace of FIG. 1;

FIG. 3 is a rear perspective view illustration of a portion of the cabinet assembly of FIG. 1, including a portion of the cabinet and a portion of the electric fireplace;

FIG. 4 is an enlarged rear perspective view illustration of a portion of the cabinet assembly of FIG. 1, including a portion of the cabinet and a portion of the electric fireplace;

FIG. 5 is a front perspective view illustration of an insert assembly having features of the present invention that can be incorporated into the electric fireplace of FIG. 1;

FIG. 6 is a front perspective view illustration of the insert assembly of FIG. 5 with some of the otherwise hidden components now illustrated in phantom;

FIG. 7 is a rear perspective view illustration of the insert assembly of FIG. 5;

FIG. 8 is a rear perspective view illustration of the insert assembly of FIG. 5 with some of the otherwise hidden components now illustrated in phantom;

FIG. 9 is a first perspective cut-away view illustration of the insert assembly of FIG. 5; and

FIG. 10 is a second perspective cut-away view illustration of the insert assembly of FIG. 5.

While embodiments of the present invention are susceptible to various modifications and alternative forms, specifics thereof have been shown by way of examples and drawings and are described in detail herein. It is understood, however, that the scope herein is not limited to the particular embodiments described. On the contrary, the intention is to cover modifications, equivalents, and alternatives falling within the spirit and scope herein.

### DESCRIPTION

Embodiments of the present invention are described herein in the context of a modular assembly for a rear projection electric fireplace. More particularly, the modular assembly and design for the electric fireplace enables greater flexibility to the consumer for the overall design of the electric fireplace, as well as offering various cost and product development efficiencies. For example, numerous options for different components of the electric fireplace can be incorporated together in any desired manner to provide various alternatives for the consumer in terms of the overall size, shape, design and aesthetic appearance of the electric fireplace. In various embodiments, the components of the electric fireplace can be configured relative to one another so that they can be packaged together much more compactly, which can provide desired cost efficiencies. In several embodiments, the electric fireplace further includes an insert assembly and/or a simulated flame assembly that incorporates a rear projection design that is not found in previous embodiments. In many embodiments, electrical connections for certain components of the electric fireplace can be configured to enable the consumer to easily and safely establish such electrical connections so that power and control is provided to all such electrical components of the electric fireplace. In certain embodiments, the cabinet can also be provided to the consumer in the form of a modular cabinet assembly that is configured to be assembled, along with the electric fireplace, by the consumer.

Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same or similar nomenclature and/or reference indicators will be used throughout the drawings, and the following detailed description to refer to the same or like parts.

In the interest of clarity, not all of the routine features of the implementations described herein are shown and described. It is appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

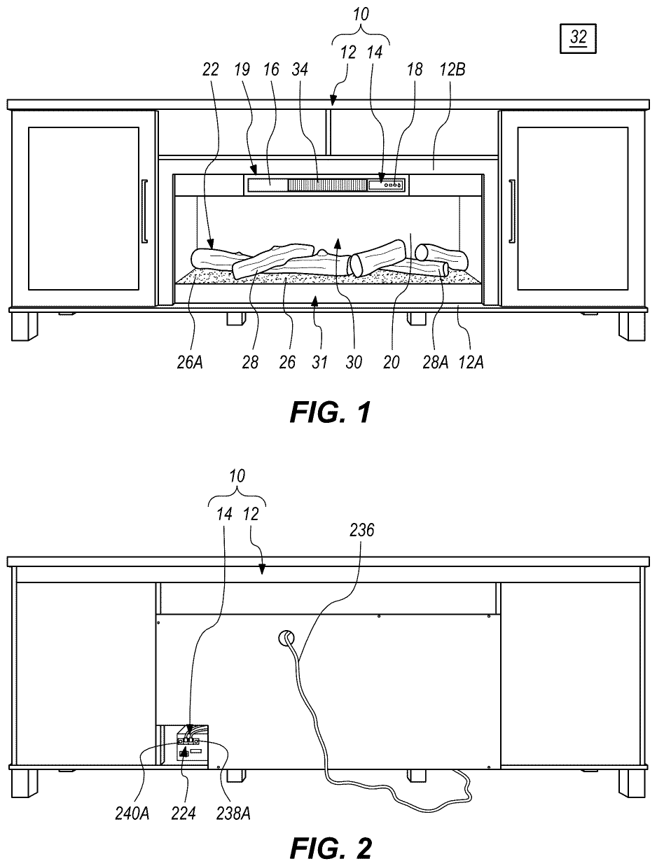

FIG. 1 is a simplified front view illustration of a cabinet assembly 10 including a cabinet 12 and an embodiment of an electric fireplace 14 having features of the present invention. As shown, the electric fireplace 14 is positioned within and/or integrated into the cabinet 12, such as within a cabinet opening 12A of the cabinet 12 that is configured to receive the electric fireplace 14.

In the non-exclusive implementation of FIG. 1, the cabinet assembly 10 is provided in the form of a modular cabinet assembly. In particular, as illustrated and described herein, the electric fireplace 14 has a modular design that is configured to be assembled by the consumer via a knock/down (“K/D”) method. In some embodiments, the cabinet 12 can also have a modular design that is configured to be assembled by the consumer via a knock/down (“K/D”) method, prior to and/or in conjunction with the assembly and installation of the electric fireplace 14 within the cabinet opening 12A of the cabinet 12. As thus provided herein, various components of the cabinet 12 and/or the electric fireplace 14 can be configured to fit together compactly when installed and in use, and/or during packaging, shipping and/or storing of the cabinet assembly 10. With such design, all of the components of the cabinet assembly 10 can be provided in a much smaller overall package.

It is appreciated that in embodiments where the cabinet 12 is assembled via a K/D method, a package assembly (not shown) that is configured to retain the entire cabinet assembly 10 (the combined packaging of the cabinet 12 and the electric fireplace 14) can provide additional cost efficiencies for packaging, shipping, storing, etc. based on the smaller overall package assembly that would be required to contain all components of the cabinet 12 and the electric fireplace 14. It is further appreciated that the modular electric fireplace 14 and the modular cabinet 12, when in an unassembled configuration, are able to retain a desired more compact, reduced form factor in comparison to the prior designs.

With such design, a more compact, reduced form factor of the package assembly can greatly reduce the cost of shipping and storing of the cabinet assembly 10. In some embodiments, the package assembly can have a reduced form factor relative to a typical prior art package assembly such that the package assembly has an overall size that is less than approximately 40% and 90% of the size of the prior art package assembly. More particularly, in certain non-exclusive embodiments, the reduced form factor of the package assembly is less than approximately 40%, 45%, 50%, 55%, 60%, 65%, 70%, 75%, 80%, 85% or 90% of the form factor of the prior art package assembly. Additionally, in various embodiments, the package assembly can have a package form factor that is substantially equal to, or is only slightly larger than, a form factor of the electric fireplace 14 and the cabinet 12 together when they are in the unassembled configuration.

The cabinet 12 can have any suitable design. More specifically, it is appreciated that the cabinet 12 and/or the cabinet opening 12A can be of any suitable size, shape and design, which can be different than what is specifically shown in FIG. 1. Thus, the specific size, shape and design of the cabinet 12 and/or the cabinet opening 12A illustrated in the Figures is not intended to be limiting in any manner.

Moreover, the cabinet 12 can be assembled in any suitable manner. In particular, in many embodiments, the various components of the cabinet 12 can be manufactured independently of one another, and can be assembled and/or installed independently of one another at the consumer level to create the desired cabinet 12 and/or the desired cabinet opening 12A. It is merely appreciated that the overall cabinet opening 12A be configured to effectively receive the desired design, size and shape of the electric fireplace 14.

As illustrated herein, the electric fireplace 14 can be used to provide heat and/or to simulate a wood burning fire, such as in a room of a home or other type of building. More particularly, in certain embodiments, the electric fireplace 14 can be configured to look like a traditional wood-burning fireplace, although the electric fireplace 14 does not actually burn wood.

The design of the electric fireplace 14 can be varied. In various embodiments, the electric fireplace 14 can include one or more of (i) a heater assembly 16; (ii) a controller 18; (iii) a front panel 20; (iv) a fireplace insert 22; and (v) an electrical connection assembly 224 (illustrated in FIG. 2). In some embodiments, such as shown in FIG. 1, the heater assembly 16 and the controller 18 can be packaged together into an integrated electrical insert 19. In many embodiments, the fireplace insert 22 can include one or more of an ember bed 26, a log assembly 28 including one or more logs 28A, and a simulated flame assembly 30 that is configured to generate a simulated flame 630A (illustrated in phantom in FIG. 6) within the electric fireplace 14. As illustrated and described herein, the ember bed 26 and the simulated flame assembly 30 can also be referred to collectively as an insert assembly 31. Alternatively, the electric fireplace 14 and/or the fireplace insert 22 can include more components or fewer components than those specifically illustrated in FIG. 1. For example, in one non-exclusive alternative embodiment, the electric fireplace 14 can be designed without the heater assembly 16 and/or the front panel 20. Still alternatively, in some embodiments, the electric fireplace 14 can further include a fireplace housing (not shown), which can include a base panel, a back panel, and side panels to support various other components of the electric fireplace 14. Yet alternatively, the various components of the electric fireplace 14 and/or the fireplace insert 22 can be positioned in a different manner than that shown in FIG. 1.

With the product design as described in detail herein, the various components of the cabinet 12 and the electric fireplace 14 can be manufactured independently of one another, and can be installed independently of one another at the consumer level. Moreover, due to the inclusion of the easy-to-use electrical connection assembly 224, the consumer is able to easily and safely establish all necessary electrical connections, such as between the heater assembly 16 and/or the controller 18 (the electrical insert 19) and the fireplace insert 22, and between the heater assembly 16 and/or the controller 18 (the electrical insert 19) and an external power source 32 (illustrated as a box) such as an electrical outlet.

As an overview, as noted above, in certain embodiments, the electric fireplace 14 is uniquely formed with a modular design such that various components are manufactured and installed independently of one another. Stated in another manner, the electric fireplace 14 can be constructed via a knock/down (“K/D”) method, and one or more of the components of the electric fireplace 14 can be K/D components that can be individually installed by the user or consumer. Moreover, certain components of the electric fireplace 14 can be positioned in different locations within the cabinet opening 12A of the cabinet 12 to suit the particular desires of the consumer. With such design, the electric fireplace 14 can be constructed by the consumer, i.e. at the consumer level, from the component parts, and need not be constructed at the manufacturer/factory level as is done with typical electric fireplaces. The electric fireplace 14 and the components thereof can thus be configured to have any suitable size, shape, design and aesthetic appearance depending on the preferences of the consumer.

Moreover, in the implementation of FIG. 1, the electric fireplace 14 does not include a fireplace housing with a base panel, a back panel, and side panels. Instead, the components of the electric fireplace 14 are supported by the cabinet 12 itself. Thus, with the modular design described herein, the consumer is provided with a larger variety of options for the overall design, size, shape and aesthetic appearance of the electric fireplace 14, thus enhancing consumer control and happiness, while still enabling various cost and product development efficiencies.

As further shown, in many embodiments, the electric fireplace 14 and/or the fireplace insert 22 can incorporate a rear projection design that is not present in previously available modular electric fireplaces.

The heater assembly 16, such as an integrated electric heater assembly in some embodiments, is configured to generate heated air which can be directed in a generally outward direction away from the electric fireplace 14. More particularly, in certain embodiments, the heater assembly 16 can include a heater body (not shown), a heat generator (not shown) and a fan or blower (not shown) that are positioned substantially within the heater body, and a grill cover 34, such as in the form of heat vents, that is positioned substantially directly adjacent to and/or is mechanically coupled or secured to the heater body. In such embodiments, the heat generator is configured to generate heat, and the blower is configured to blow the heat from the heat generator in the form of hot air through an air outlet (not shown) formed into the heater body and subsequently through the grill cover 34 into the area surrounding the electric fireplace 14, such as a room in a house, in order to heat such area.

The heater assembly 16 can be positioned in any suitable manner within a fully assembled cabinet assembly 10. In certain implementations, the heater assembly 16 can be attached to the cabinet 12 independently of the front panel 20 and/or the fireplace insert 22. For example, in some embodiments, as shown in FIG. 1, the cabinet 12 can include a center shelf 12B, and the heater assembly 16 and/or the grill cover 34 can be attached to, mounted on and/or positioned substantially adjacent to the center shelf 12B of the cabinet 12. More particularly, in one embodiment, the heater assembly 16 can be fixedly attached to the center shelf 12B of the cabinet 12, and the heater assembly 16 can be positioned in the cabinet opening 12A during assembly of the center shelf 12B to the rest of the components of the cabinet 12. In such embodiment, at least a majority of the components of the electric fireplace 14, such as at least the fireplace insert 22 and the components thereof, will be positioned within the cabinet opening 12A of the cabinet 12 below the center shelf 12B, with the heater assembly 16 being attached to, mounted on and/or positioned substantially adjacent to the center shelf 12B of the cabinet 12 and above the other components of the electric fireplace 14. Alternatively, the heater assembly 16 can be positioned in another suitable manner and/or installed at a different location, which can be independently of the center shelf 12B.

The controller 18 can include one or more circuits or processors that can be utilized to control the various functions of the electric fireplace 14. For example, the controller 18 can be utilized to activate and/or control (i) the amount of heat generated by the heater assembly 16; (ii) the intensity of a glowing effect that may be generated for the ember bed 26; (iii) the intensity of a glowing effect that may be generated for the log assembly 28; and/or (ii) the intensity, shape, and profile of the simulated flame 630A that is generated by the simulated flame assembly 30.

As noted above, in some embodiments, the heater assembly 16 and the controller 18 can be packaged together into the integrated electrical insert 19. Alternatively, the controller 18 can be integrated into the fireplace insert 22. Still alternatively, the controller 18 can be provided independently of both the heater assembly 16 and the fireplace insert 22.

It is appreciated that in some implementations, certain electrical components of the electric fireplace 14, such as the heater assembly 16 and the controller 18 that can be combined to form the electrical insert 19, can be fully assembled at the factory level prior to the components being packaged and shipped commercially. Alternatively, some assembly of such electrical components can be done at the consumer level, provided necessary safety requirements can be met.

In various embodiments, power can be provided directly or indirectly to the heater assembly 16, the controller 18 and/or the electrical insert 19 from the external power source 32 or another suitable power source via the electrical connection assembly 224. For example, in one non-exclusive embodiment, the electrical connection assembly 224 can include a power cord 236 (illustrated in FIG. 2) that is selectively electrically coupled to and between the external power source 32 and the heater assembly 16, the controller 18 and/or the electrical insert 19.

The front panel 20 provides viewing of the fireplace insert 22 as the fireplace insert 22 is positioned within the cabinet opening 12A of the cabinet 12. For example, the front panel 20 can be a piece of glass or another type of transparent material. In one implementation, the front panel 20 is attached to the cabinet 12 independently of the heater assembly 16 and/or the fireplace insert 22.

The fireplace insert 22 can be designed to simulate a woodburning fire or another situation. In one non-exclusive implementation, the fireplace insert 22 is installed in the cabinet opening 12A from the back, after the cabinet 12 is at least partially assembled, independently of the heater assembly 16 and/or the front panel 20.

As noted above, in certain embodiments, the fireplace insert 22 includes the ember bed 26, a log assembly 28, and the simulated flame assembly 30. Alternatively, the fireplace insert 22 can be designed to include more or fewer components than are illustrated in FIG. 1. For example, the fireplace insert 22 could be designed to further include a grate (not shown) for retaining the log assembly 28. Still alternatively, the fireplace insert 22 can be designed without the log assembly 28 and/or without the ember bed 26.

The ember bed 26 can be designed to simulate a glowing or smoldering area near the simulated flame 630A to further enhance the overall look of the electric fireplace 14 to be more like that of a traditional wood-burning fireplace. In FIG. 1, the ember bed 26 is positioned substantially directly below the log assembly 28. Stated in another manner, as shown, the ember bed 26 is positioned to support at least a portion of the log assembly 28, with the log assembly 28 being positioned substantially directly above the ember bed 26. Alternatively, the ember bed 26 can be positioned in another suitable manner.

The ember bed 26 can be formed from any suitable materials. For example, in certain non-exclusive alternative embodiments, the ember bed 26 can be formed from a molded resin material, and can include a plurality of pieces of glass 26A and/or rocks that are illuminated with a suitable ember bed illumination source (not shown in FIG. 1) to simulate the glowing or smoldering area in front of the simulated flame assembly 30. Alternatively, the ember bed 26 can be formed from another suitable material, and/or have a different design.

As noted above, the log assembly 28 can include the one or more logs 28A that are further usable to further enhance the overall look of the electric fireplace 14 to be more like that of a traditional wood-burning fireplace. For example, the logs 28A can be simulated logs that appear to have been burnt or are burning. Upon installation, the log assembly 28 can be positioned substantially on top of and/or above the ember bed 26 within the cabinet opening 12A. Alternatively, for example, one or more of the logs 28A can be integrally formed with the ember bed 26.

The logs 28A can be formed from any suitable materials. For example, in certain non-exclusive alternative embodiments, the logs 28A can be hollow molded logs that are formed from a molded resin material. Alternatively, the logs 28A can be formed from another suitable material.

Optionally, the log assembly 28 can utilize a log light source (not shown) that illuminates the logs 28A to create a glowing effect for the logs 28A to provide the appearance of burning logs, thereby closely simulating the flames of a wood-burning fireplace. Alternatively, for example, the logs 28A can be illuminated by a common light source that is also utilized by the ember bed 26 and/or the simulated flame assembly 30.

The simulated flame assembly 30 generates the simulated flame 630A and is configured to give the electric fireplace 14 a more realistic appearance, such as to make the electric fireplace 14 look more like a traditional wood-burning fireplace. Certain embodiments illustrating the design of the simulated flame assembly 30 are described in more detail below.

As noted, the electrical connection assembly 224 is configured to easily and safely establish all necessary electrical connections between various components of the electric fireplace 14. More particularly, in many embodiments, the electrical connection assembly 224 is configured to easily and safely establish electrical connections between the electrical insert 19 (the heater assembly 16 and/or the controller 18) and the external power source 32, and between the electrical insert 19 (the heater assembly 16 and/or the controller 18) and the fireplace insert 22.

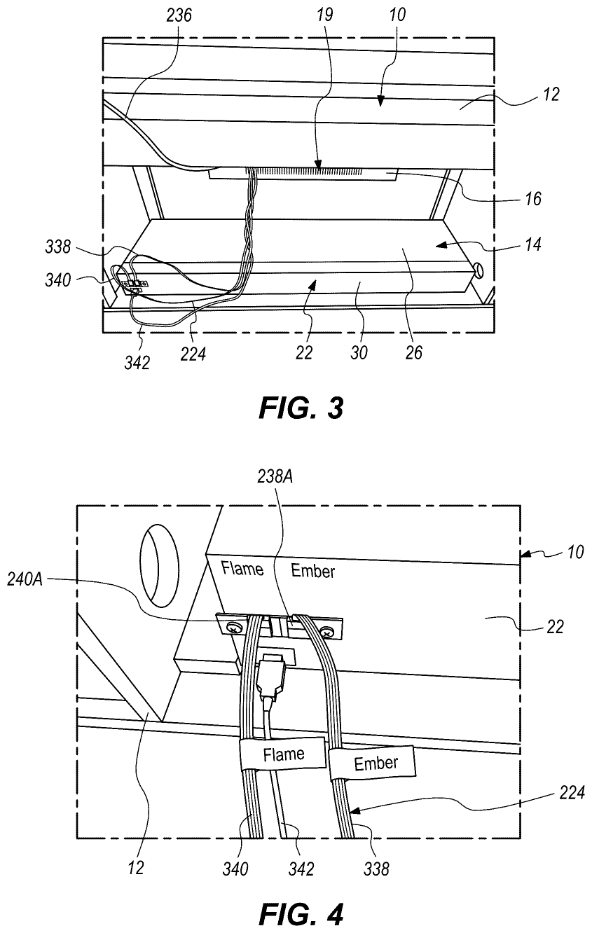

In certain embodiments, the electrical connection assembly 224 can include (i) the power cord 236 that is selectively electrically coupled to and between the external power source 32 and the electrical insert 19 (the heater assembly 16 and/or the controller 18) to provide necessary power to the electrical insert 19 (the heater assembly 16 and/or the controller 18); (ii) a first electrical connector 338 (illustrated more clearly in FIG. 3) that is selectively electrically coupled to and between the electrical insert 19 (the heater assembly 16 and/or the controller 18) and the ember bed 26 to provide necessary control and/or power to the ember bed 26 to generate a glowing effect for the ember bed 26; and (iii) a second electrical connector 340 (illustrated more clearly in FIG. 3) that is selectively electrically coupled to and between the electrical insert 19 (the heater assembly 16 and/or the controller 18) and the simulated flame assembly 30 to provide necessary control and/or power to the simulated flame assembly 30 to create the desired simulated flame 630A within the electric fireplace 14. In some embodiments, the first electrical connector 338 and/or the second electrical connector 340 can further be usable to provide necessary control and/or power to the log assembly 28 when it is desired to generate a glowing effect for the logs 28A of the log assembly 28.

In certain embodiments, the electrical connection assembly 224 can further include a second power cord 342 (illustrated in FIG. 3) that can be selectively electrically coupled to and between the external power source 32 and the fireplace insert 22 and/or between the electrical insert 19 (the heater assembly 16 and/or the controller 18) and the fireplace insert 22 to provide necessary power to the fireplace insert 22. Further details of the electrical connection assembly 224 and the components thereof will be illustrated and described in greater detail in relation to subsequent Figures.

It is appreciated that such quick and easy electrical connections possible for the consumer with the electrical connection assembly 224 provide a much more user-friendly experience for the consumer that does not entail hard-wired electrical connections which are typical in previous electric fireplaces.

FIG. 2 is a simplified rear view illustration of the cabinet assembly 10, including the cabinet 12 and the electric fireplace 14 of FIG. 1. As shown, a portion of the electrical connection assembly 224 is illustrated in FIG. 2. For example, a first connector receiver 238A that is configured to selectively receive the first electrical connector 338 (illustrated in FIG. 3), and a second connector receiver 240A that is configured to selectively receive the second electrical connector 340 (illustrated in FIG. 3), are shown through a cutout in a back panel of the cabinet 12. Additionally, the power cord 236 of the electrical connection assembly 224 is visible, which, as noted, is configured to provide power from the external power source 32 (illustrated in FIG. 1) to the electric fireplace 14.

FIG. 3 is a rear perspective view illustration of a portion of the cabinet assembly 10, again including the cabinet 12 and the electric fireplace 14 of FIG. 1. More particularly, FIG. 3 is a rear perspective view illustration of a portion of the cabinet 12, the electrical insert 19 (the heater assembly 16 and/or the controller 18 (illustrated in FIG. 1)), and a portion of the fireplace insert 22, including a portion of the ember bed 26 and the simulated flame assembly 30. It is appreciated that the glass 26A of the ember bed 26, and the log assembly 28 are not shown in FIG. 3 for purposes of clarity.

FIG. 3 also illustrates a portion of the electrical connection assembly 224, including the power cord 236, and the first electrical connector 338 and the second electrical connector 340 that selectively electrically connect the heater assembly 16 to the fireplace insert 22. With this design, for example, AC power from the external power source 32 (illustrated in FIG. 1) is provided to the electrical insert 19 (the heater assembly 16 and/or the controller 18), and power and/or control from the electrical insert 19 (the heater assembly 16 and/or the controller 18) is provided to the fireplace insert 22.

The design of the electrical connection assembly 224 can be varied pursuant to the teachings provided herein. For example, in certain embodiments, each of the first electrical connector 338 and the second electrical connector 340 can include a user-friendly, low-voltage DC connector that can be selectively electrically connected to and/or between the electrical insert 19 (the heater assembly 16 and/or the controller 18) and the fireplace insert 22 to provide the necessary control and/or power to the fireplace insert 22. More specifically, the first electrical connector 338 can include a user-friendly, low-voltage DC connector that can be selectively electrically connected to and/or between the electrical insert 19 (the heater assembly 16 and/or the controller 18) and the ember bed 26 to provide the necessary control and/or power to the ember bed 26; and the second electrical connector 340 can include a user-friendly, low-voltage DC connector that can be selectively electrically connected to and/or between the electrical insert 19 (the heater assembly 16 and/or the controller 18) and the simulated flame assembly 30 to provide the necessary control and/or power to the simulated flame assembly 30. In some such embodiments, the electrical connector assembly 224, the first electrical connector 338 and/or the second electrical connector 340 can include one or more user-friendly, low-voltage connectors, such as a USB cable assembly, a 3.5 mm jack or other suitable low-voltage DC connector.

As utilized herein, in certain non-exclusive alternative embodiments, a low-voltage connector, a low-voltage cable and/or a low-voltage cable assembly, is one that is configured to carry less than approximately 50 volts, less than approximately 45 volts, less than approximately 40 volts, less than approximately 35 volts, less than approximately 30 volts, less than approximately 25 volts, less than approximately 20 volts, less than approximately 15 volts, less than approximately 10 volts, or less than approximately 5 volts.

As further shown in FIG. 3, in certain embodiments, the second power cable 342 can be utilized to provide desired power from the electrical insert 19 (the heater assembly 16 and/or the controller 18) to the fireplace insert 22. Thus, in some embodiments, the necessary power is provided to the fireplace insert 22 from the external power source 32 via the electrical insert 19 (the heater assembly 16 and/or the controller 18).

It is appreciated that such quick and easy electrical connections possible for the consumer with the electrical connection assembly 224 provide a much more user-friendly experience for the consumer that does not entail hard-wired electrical connections which are typical in previous electric fireplaces.

FIG. 4 is an enlarged rear perspective view illustration of a portion of the cabinet assembly 10, again including a portion of the cabinet 12, a portion of the fireplace insert 22, and a portion of the electrical connection assembly 224. More specifically, FIG. 4 illustrates the first electrical connector 338 that is selectively electrically coupled to the ember bed 26 (illustrated in FIG. 1) via the first connector receiver 238A coupled into the ember bed 26, and the second electrical connector 340 that is selectively electrically coupled to the simulated flame assembly 30 (illustrated in FIG. 1) via the second connector receiver 240A coupled into the simulated flame assembly 30. As provided herein, the first electrical connector 338 is configured to provide the necessary control and/or power from the electrical insert 19 (illustrated in FIG. 1) to the ember bed 26 to provide the desired glowing effect for the ember bed 26. Additionally, the second electrical connector 340 is configured to provide the necessary control and/or power from the electrical insert 19 (illustrated in FIG. 1) to the simulated flame assembly 30 to provide the desired simulated flame 630A (illustrated in phantom in FIG. 6) for the electric fireplace 14. Further, the second power cable 342 is again shown in FIG. 4, with the second power cable 342 being configured to provide desired power from the electrical insert 19 to the fireplace insert 22.

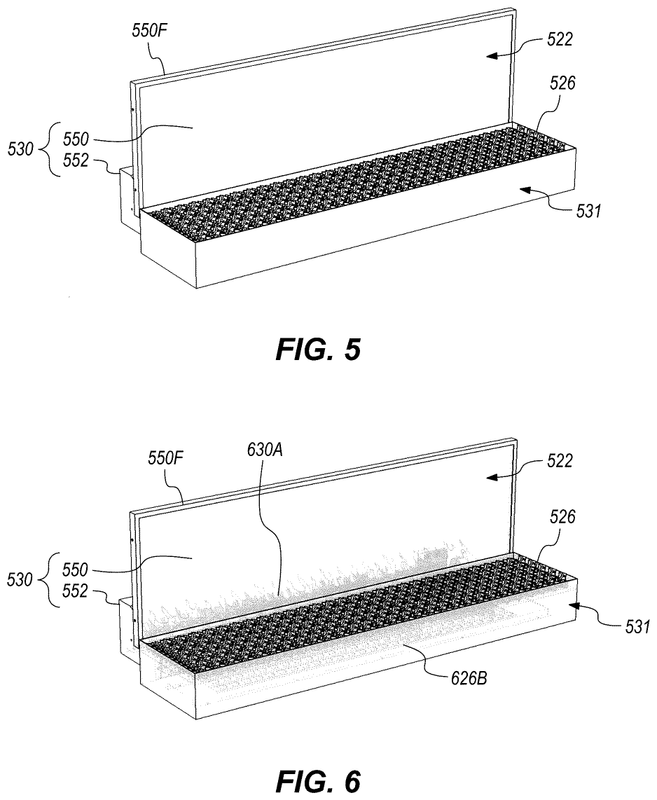

FIG. 5 is a front perspective view illustration of an embodiment of the insert assembly 531 having features of the present invention that can be incorporated into the electric fireplace 14 of FIG. 1. More particularly, FIG. 5 is a front perspective view illustration of a portion of an embodiment of the fireplace insert 522, including an embodiment of the ember bed 526 and an embodiment of the simulated flame assembly 530 that are collectively referred to as the insert assembly 531. Additionally, FIG. 6 is a front perspective view illustration of the insert assembly 531 of FIG. 5, with some of the otherwise hidden components now illustrated in phantom. It is appreciated that the glass 26A of the ember bed 526, and the log assembly 28 are not shown in FIGS. 5 and 6 for purposes of clarity.

As noted herein above, the ember bed 526 is designed to simulate a glowing or smoldering area near the simulated flame 630A (illustrated in phantom in FIG. 6) of the simulated flame assembly 530 to further enhance the overall look of the electric fireplace 14 to be more like that of a traditional wood-burning fireplace. In certain embodiments, the ember bed 526 can include a plurality of pieces of glass 26A (illustrated in FIG. 1) and/or rocks that are illuminated with a suitable ember bed illumination source 626B (illustrated in phantom in FIG. 6) to simulate the glowing or smoldering area in front of the simulated flame assembly 530.

The ember bed illumination source 626B can have any suitable design for purposes of illuminating the pieces of glass 26A and/or rocks for purposes of simulating the glowing or smoldering area in front of the simulated flame assembly 530. For example, in one non-exclusive embodiment, the ember bed illumination source 626B can include an array of LEDs that are controlled to create the desired light effect. Alternatively, the ember bed illumination source 626B can have another suitable design.

As further noted herein above, the simulated flame assembly 530 is configured to generate a simulated flame 630A to again enhance the overall look of the electric fireplace 14 to be more like that of a traditional wood-burning fireplace.

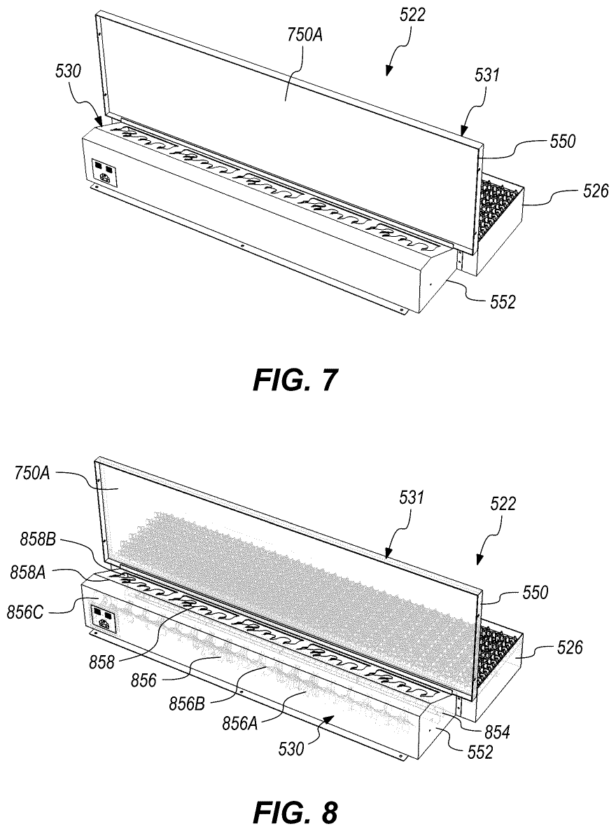

The simulated flame assembly 530 can have any suitable design for purposes of generating the desired simulated flame 630A within the electric fireplace 14. In some embodiments, such as shown in FIGS. 5 and 6, the simulated flame assembly 530 can include a projection screen 550 and a flame illumination system 552 that projects the simulated flame 630A on a rear surface 750A (illustrated in FIG. 7) of the projection screen 550. Thus, the simulated flame assembly 530 can be configured as a rear projection-type simulated flame assembly.

The projection screen 550 can have any suitable design, size and shape. As shown, in many embodiments, the projection screen 550 can be substantially rectangular-shaped and can extend in a generally upward direction away from the ember bed 526. More particularly, in this embodiment, the projection screen 550 extends upward from the ember bed 526 and is positioned substantially between the ember bed 526 and the flame illumination system 552. In certain embodiments, the projection screen 550 can further be encircled by a projection frame 550F that can rigidly support the projection screen 550. Alternatively, the projection screen 550 can have a design, size and/or shape that is different than what is specifically shown in the Figures.

The projection screen 550 and the projection frame 550F can be made of any suitable material. In some non-limiting, non-exclusive embodiments, the projection screen 550 can be formed at least partially from one or more of plexiglass, plastic, fabric, and glass. In many embodiments, the projection screen 550 can be transparent so that the simulated flame 650A, generated in the rear projection design, can be visible for a user that is positioned in front of the projection screen 550. In certain embodiments, the projection frame 550F can be formed from any suitable material, including a metal. Alternatively, the projection screen 550 and/or the projection frame 550F can be formed from other suitable materials.

Although certain embodiments of the projection screen 550 and/or the flame illumination system 552 will be illustrated and described in greater detail herein below in relation to subsequent Figures, it is appreciated that the design of these components can be varied pursuant to the teachings provided herein.

FIG. 7 is a rear perspective view illustration of the insert assembly 531 of FIG. 5. More particularly, FIG. 7 is a rear perspective view illustration of a portion of the fireplace insert 522, again including the embodiment of the ember bed 526 and the embodiment of the simulated flame assembly 530 illustrated in FIG. 5 that are collectively referred to as the insert assembly 531. Additionally, FIG. 8 is a rear perspective view illustration of the insert assembly 531 of FIG. 5, with some of the otherwise hidden components now illustrated in phantom. It is appreciated that the glass 26A of the ember bed 526, and the log assembly 28 are not shown in FIGS. 7 and 8 for purposes of clarity.

As shown, FIGS. 7 and 8 illustrate the back side, or rear surface 750A, of the projection screen 550 which is illuminated by the flame illumination system 552.

The design of the flame illumination system 552 can be varied. As shown in FIG. 8, in some embodiments, the flame illumination system 552 includes a flame light source 854 (illustrated in phantom), a beam redirector assembly 856 (illustrated in phantom), and a light shaper 858 that shapes the generated light. Alternatively, the flame illumination system 552 can include more components or fewer components than what is specifically illustrated in FIG. 8.

The flame light source 854 generates light that is directed at and illuminates the beam redirector assembly 856. The flame light source 854 can have any suitable design. For example, in one non-exclusive alternative embodiment, the flame light source 854 can include a flat, PCB board upon which is mounted an LED panel having one or more LED light bulbs. Alternatively, the flame light source 854 can have another suitable design, such as including other types of light bulbs or another type of light source. Additionally, the flame light source 854 can be positioned in any suitable manner.

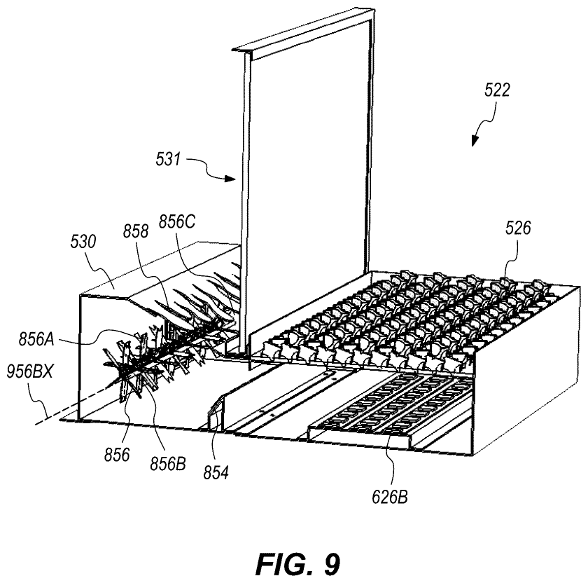

The beam redirector assembly 856 redirects the light generated by the flame light source 854 at the light shaper 858. In some non-exclusive embodiments, the beam redirector assembly 856 includes an array of reflectors 856A (such as mirrors in one embodiment) that are being rotated about an axis. In certain embodiments, the beam redirector assembly 856 includes a beam redirector rod 856B coupled to a beam redirector mover 856C (such as a motor in some embodiments), and the array of reflectors 856A. The beam redirector mover 856C can move the beam redirector rod 856B so that the array of reflectors 856A rotates about a rod axis 956BX (illustrated more clearly in FIG. 9) of the beam redirector rod 856B.

With this design, the reflected light will appear to flicker as the reflectors 856A are rotated about the rod axis 956BX. The array of reflectors 856A can vary and can be formed from any suitable material. In certain non-limiting, non-exclusive embodiments, the array of reflectors 856A is formed from a plastic material.

The light shaper 858 shapes the generated light into a flame-type shape that is projected as a flame-like image onto the rear surface 750A of the projection screen 550. In the embodiment shown in FIG. 8, the light shaper 858 includes a shaper housing 858A with a flame-like cutout 858B. The light shaper 858 can vary in design, height and/or angles needed to form the flame-type shape that is desired.

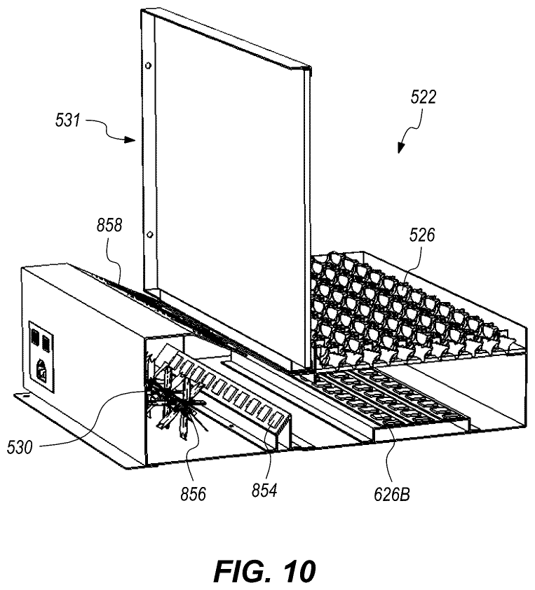

FIG. 9 is a first perspective cut-away view illustration of the insert assembly 531 of FIG. 5. More particularly, FIG. 9 is a first perspective cut-away view illustration of a portion of the fireplace insert 522, including the embodiment of the ember bed 526 and the embodiment of the simulated flame assembly 530 illustrated in FIG. 5. Additionally, FIG. 10 is a second perspective cut-away view illustration of the insert assembly 531 of FIG. 5. It is again appreciated that the glass 26A of the ember bed 526, and the log assembly 28 are not shown in FIGS. 9 and 10 for purposes of clarity.

Different views of the ember bed illumination source 626B, the flame light source 854, the beam redirector assembly 856, and the light shaper 858 are also shown in FIGS. 9 and 10. The components of the beam redirector assembly 856, including the plurality of reflectors 856A, the beam redirector rod 856B, and the beam redirector motor 856C are also illustrated in FIG. 9.

It is understood that although a number of different embodiments of the cabinet assembly 10 and/or the electric fireplace 14 have been illustrated and described herein, one or more features of any one embodiment can be combined with one or more features of one or more of the other embodiments, provided that such combination satisfies the intent of the present invention.

While a number of exemplary aspects and embodiments of the cabinet assembly 10 and/or the electric fireplace 14 have been discussed above, those of skill in the art will recognize certain modifications, permutations, additions, and sub-combinations thereof. It is therefore intended that the following appended claims and claims hereafter introduced are interpreted to include all such modifications, permutations, additions, and sub-combinations as are within their true spirit and scope, and no limitations are intended to the details of construction or design herein shown.

What is claimed is:

1. An electric fireplace for installation into a cabinet having a cabinet opening, the electric fireplace comprising:
a heater assembly that is configured to generate heated air; and
a fireplace insert that is configured to be installed into the cabinet opening independently of the heater assembly, the fireplace insert including a simulated flame assembly that projects a flame-like image onto a surface to create a simulated flame within the electric fireplace.

2. The electric fireplace of claim 1 wherein the simulated flame assembly includes a projection screen and a flame illumination system that projects the flame-like image onto a rear surface of the projection screen.

3. The electric fireplace of claim 2 wherein the flame illumination system includes a flame light source that generates light which can be used to project the flame-like image onto the rear surface of the projection screen.

4. The electric fireplace of claim 3 wherein the flame illumination system further includes a beam redirector assembly that redirects the light generated by the flame light source toward the rear surface of the projection screen.

5. The electric fireplace of claim 4 wherein the beam redirector assembly includes an array of reflectors that are mounted on a beam redirector rod having a rod axis; and wherein the array of reflectors is rotatable about the rod axis.

6. The electric fireplace of claim 5 wherein rotation of the array of reflectors about the rod-like axis causes the flame-like image that is projected onto the rear surface of the projection screen appears to flicker.

7. The electric fireplace of claim 3 wherein the flame illumination system further includes a light shaper that shapes the light generated by the flame light source prior to the light being used to project the flame-like image onto the rear surface of the projection screen.

8. The electric fireplace of claim 7 wherein the light shaper includes a shaper housing and a flame-like cutout that is formed into the shaper housing.

9. The electric fireplace of claim 1 further comprising an electrical connection assembly that selectively, electrically connects the fireplace insert to the heater assembly.

10. The electric fireplace of claim 9 wherein the electrical connection assembly includes a low-voltage DC connector that selectively, electrically connects the fireplace insert to the heater assembly.

11. The electric fireplace of claim 10 wherein the electrical connection assembly further includes an AC power cord that selectively, electrically connects the heater assembly to an external power source.

12. The electric fireplace of claim 1 further comprising a controller including a processor that is coupled to the heater assembly, the controller being configured to control operation of the heater assembly and the fireplace insert.

13. The electric fireplace of claim 1 wherein the fireplace insert includes at least one of an ember bed and a log assembly.

14. The electric fireplace of claim 13 wherein the fireplace insert includes each of the ember bed and the log assembly.

15. The electric fireplace of claim 1 wherein the heater assembly is positioned above the fireplace insert when the heater assembly and the fireplace insert are installed within the cabinet opening.

16. An electric fireplace for installation into a cabinet having a cabinet opening, the electric fireplace comprising:
a heater assembly that is configured to generate heated air;
a fireplace insert that is configured to be installed into the cabinet opening independently of the heater assembly, the fireplace insert including a simulated flame assembly including a projection screen and a flame illumination system that projects a flame-like image onto a rear surface of the projection screen, the flame illumination system including (i) a flame light source that generates light, (ii) a beam redirector assembly that redirects the light generated by the flame light source toward the rear surface of the projection screen, the beam redirector assembly including an array of reflectors that are mounted on a beam redirector rod having a rod axis, the array of reflectors being rotatable about the rod axis, and (iii) a light shaper that shapes the light generated by the flame light source and redirected by the beam redirector assembly prior to the light being used to project the flame-like image onto the rear surface of the projection screen; and
an electrical connection assembly that selectively, electrically connects the fireplace insert to the heater assembly.

17. The electric fireplace of claim 16 wherein the light shaper includes a shaper housing and a flame-like cutout that is formed into the shaper housing.

18. The electric fireplace of claim 16 wherein the electrical connection assembly includes (i) a low-voltage DC connector that selectively, electrically connects the fireplace insert to the heater assembly, and (ii) an AC power cord that selectively, electrically connects the heater assembly to an external power source.

19. The electric fireplace of claim 16 further comprising a controller including a processor that is coupled to the heater assembly, the controller being configured to control operation of the heater assembly and the fireplace insert.

20. The electric fireplace of claim 16 wherein the fireplace insert includes at least one of an ember bed and a log assembly.
